(19) United States
(12) Patent Application Publication
(10) Pub. No.: US 2026/0115732 A1
(43) Pub. Date: Apr. 30, 2026

(54) PORTABLE BLENDER

(71) Applicant: Guangdong Shunde Wellife Electrical Appliances MFG. CO., LTD, Foshan (CN)

(72) Inventor: Jianxin Wen, Foshan (CN)

(21) Appl. No.: 19/009,880

(22) Filed: Jan. 3, 2025

(30) Foreign Application Priority Data
Oct. 29, 2024 (CN) 202422632624.7
Oct. 29, 2024 (CN) 202422633015.3
Oct. 29, 2024 (CN) 202422633132.X
Dec. 13, 2024 (CN) 202423095525.6

(51) Int. Cl. B02C 13/14; A47J 43/046; A47J 43/07; A47J 43/08

(52) U.S. Cl. CPC B02C 13/14; A47J 43/046; A47J 43/0722; A47J 43/0761; A47J 43/085

(57) ABSTRACT

The present invention discloses a portable blender comprising a cup body, a blade seat, a machine seat, and a control panel, a motor and a driving seat, wherein the cup body is detachably connected with the blade seat detachably connected with the machine seat provided with a safety switch, the blade seat includes a blade tray provided with a first through hole, a rotating shaft, a stirring blade set and a driven seat, a first sealing ring encircles the blade tray and is provided with a first protrusion passing through the first through hole and used to support the safety switch. In the present invention, the blade seat and the machine seat are arranged independently, making it convenient to detach and clean the blender in safety, and the first protrusion arranged on the first sealing ring supports the safety switch, ensuring the safety of use.

### CROSS-REFERENCE TO RELATED APPLICATION

This application claims priorities of Chinese Patent Application No. 202422632624.7, filed on Oct. 29, 2024; Chinese Patent Application No. 202422633015.3, filed on Oct. 29, 2024; Chinese Patent Application No. 202422633132.X, filed on Oct. 29, 2024 and Chinese Patent Application No. 202423095525.6, filed on Dec. 13, 2024, the entire contents of which are incorporated herein by reference.

### TECHNICAL FIELD

The present invention relates to the technical field of blenders, in particular to a portable blender.

### BACKGROUND

Some need such as crushing and stirring food and pressing juice often occurs to people in their daily family life, so portable blenders are gradually prevailing in the market, now commonly used as a mini-type appliance in a family kitchen and also make it convenient to take to the outdoors. A portable blender typically includes a mixing cup body, a blade seat, and a blade driving mechanism installed on a blender base. A blade seat of existing portable blenders is usually installed non-detachably on a machine seat, making it inconvenient to clean it and causing safety problems due to possibility that water will flow into the electrical parts inside the seat during cleaning. In addition, many portable blenders have an ejector-pin structure with a safety switch and a trigger, but bring about more complexity in structure and low production efficiency, and further poor stirring effect and capability to crush ice in terms of product performance.

### SUMMARY

An objective of the present invention is to provide a portable blender, which make it convenient to clean, safe to use, and possible to low production costs and improve stirring effect and capability to crush ice, so as to overcome the defects of the prior art.

A portable blender includes a cup body, a blade seat, a machine seat, and a control panel, a motor and a driving seat that are arranged inside the machine seat, the motor driving the driving seat to rotate, characterized in that the cup body is detachably connected with the blade seat, the blade seat is detachably connected with the machine seat, the machine seat is provided with a safety switch, the blade seat includes a blade tray, a rotating shaft, a stirring blade set and a driven seat, the blade tray is provided with a first through hole, a first sealing ring encircles the blade tray, the first sealing ring is provided with a first protrusion, which passes through the first through hole, and the first protrusion is used to support the safety switch.

Further, the stirring blade set includes a wing base, and a first blade wing and a second blade wing that extend outwards from a periphery of the wing base and are positioned opposite to each other, the center of the wing base is provided with a installation hole, a blade is set on each of these blade wings, the first blade wing is set to be a two-section structure bent downwards in L-shape with respect to a plane of the wing base, and the second blade wing is set to be a three-section structure bent downwards in U-shape with respect to the plane of the wing base.

Further, the blade tray is provided with a second protrusion, the second protrusion is set to be adjacent to the first through hole, the first sealing ring is provided with a hollow sleeve, and the second protrusion is adapted to and inserted in the hollow sleeve.

Further, the middle portion of the blade tray sinks upwards and extends to form an installation cavity, a second through hole is set on the top of the installation cavity, a third protrusion is set on the bottom of the installation cavity, and the third protrusion is caught by a revolve fastener on the machine seat.

Further, the safety switch includes a spring assembly and a switch, the switch is used to make contact or break contact in a motor driving circuit, and the spring assembly includes a guide block and an ejector spring, the cup body is installed on the blade seat, an open end of the cup body enables the first protrusion to overcome an elastic force of the ejector spring and press the guide block toward the switch, so that the switch makes contact in the motor driving circuit.

Further, an angle α formed by bending a first section of the first blade wing downwards with respect to the plane of the wing base is 45-80°, an angle β formed by bending back a second section of the first blade wing upwards with respect to the first section of the first blade wing is 20-40°, an angle γ formed by bending a first section of the second blade wing downwards with respect to the plane of the wing base is 45-80°, an angle θ formed by bending back a second section of the second blade wing upwards with respect to the first section of the second blade wing is 45-80°, an angle ζ formed by bending a third section of the second blade wing upwards with respect to the second section of the second blade wing is 60-85°.

The present invention has the following beneficial effects.
1) The portable blender of the present invention has the cup body, the blade seat and the machine seat that are arranged independently, making it convenient to detach and clean the blender. The first sealing ring with protrusions on both sides is arranged on the blade seat, and the protrusion at its lower end touches the safety switch; only after the cup body is installed on the blade seat, this protrusion presses the safety switch, so as to guarantee the safety of the blender.
2) In addition, another protrusion of the blade seat further guarantees the safety of use. Because the space between this protrusion and the wall of the blade seat is narrow, fingers cannot reach into it, thus preventing the switch from being touched by mistake. This protrusion of the blade seat performs the function in stirring and disturbing flow, improving stirring effect and capability to crush food.
3) The hollow sleeve protrudes from a plane of the body of the first sealing ring; thus, users can easily hold the hollow sleeve in their hand and take out the first sealing ring from the blade seat for cleaning.

### BRIEF DESCRIPTION OF THE DRAWINGS

FIG. 1 is a three-dimensional view of the blender according to the present invention.

FIG. 2 is an exploded view of the blender according to the present invention.

FIG. 3 is a schematic diagram showing positive and negative structures of the blade seat according to the present invention.

FIG. 4 is a schematic diagram showing positive and negative structures of the first sealing ring according to the present invention.

FIG. 5 is a sectional view of the blender according to the present invention.

FIG. 6 is a structure diagram of the safety switch of the machine seat of the present invention.

FIG. 7 is a sectional view of the first embodiment of the blade seat of the present invention.

FIG. 8 is a sectional view of the second embodiment of the blade seat of the present invention.

FIG. 9 is a three-dimensional view of the stirring blade set according to the present invention.

FIG. 10 is a front view of the stirring blade set according to the present invention.

FIG. 11 is a schematic diagram showing how to install the blade seat in the second example.

FIG. 12 is a sectional view of a triggering structure of the safety switch in the second example.

FIG. 13 is a top view and a partial enlarged view of the blade seat in the second example.

FIG. 14 is a bottom view of the blade seat in the second example.

FIG. 15 is a structure diagram of the switching movable piece in the second example.

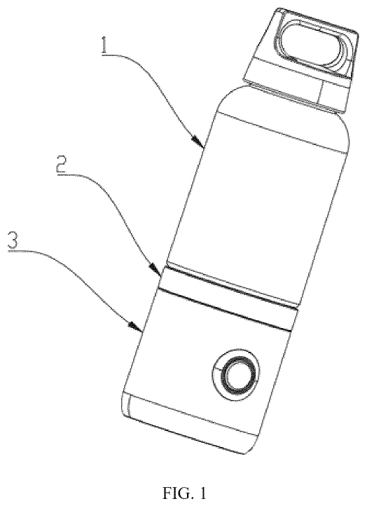

Wherein, the correspondence between the marks in FIG. 1˜10 and the element names are as follow.

1—cup body; 2—blade seat; 3—machine seat; 4—cup cap; 5—blade tray; 6—rotating shaft; 7—driven seat; 8—first through hole; 9—second protrusion; 10—first sealing ring; 11—first protrusion; 12—hollow sleeve; 13—installation cavity; 14—second through hole; 15—stirring blade set; 16—housing; 17—motor; 18—safety switch; 18a—guide block; 18b—ejector spring; 18c—switch; 19—base; 20—driving seat; 21—third protrusion; 22—fifth protrusion; 23—cylindrical wall surface; 24—revolve fastener; 25—reinforcing sleeve; 27—gasket; 28—second sealing ring; 29—third sealing ring; 30—bearing; 32—wing base; 33—installation hole; 34—first blade wing; 34a—first section of the first blade wing; 34b—second section of the first blade wing; 35—second blade wing; 35a—first section of the second blade wing; 35b—second section of the second blade wing; 35c—third section of the second blade wing; 36—first blade; 37—second blade; 171—lithium battery; 172—control panel; 50—switching movable piece; 51—switching jacking rod; 52—jacking spring; 53—spring seat; 81—slot hole; 82—supporting plate; 83—position-restricting block; 501—partition; 502—rising plate; 503—anti-falling block; 504—partition notch; 505—wedge surface.

### DETAILED DESCRIPTION OF THE EMBODIMENTS

We shall describe the technical solution of the present invention clearly and completely in combination with the figures as follows.

### Example 1

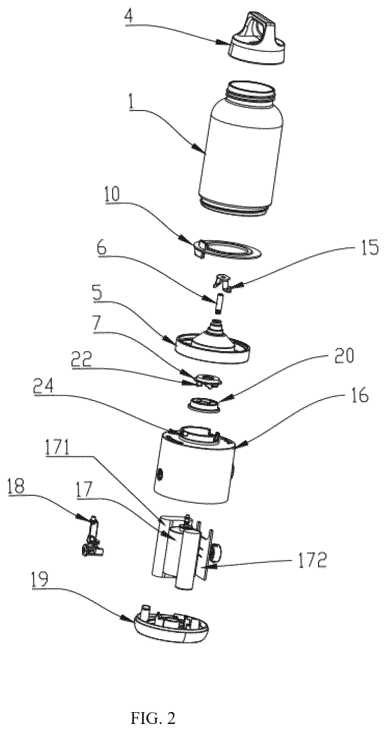

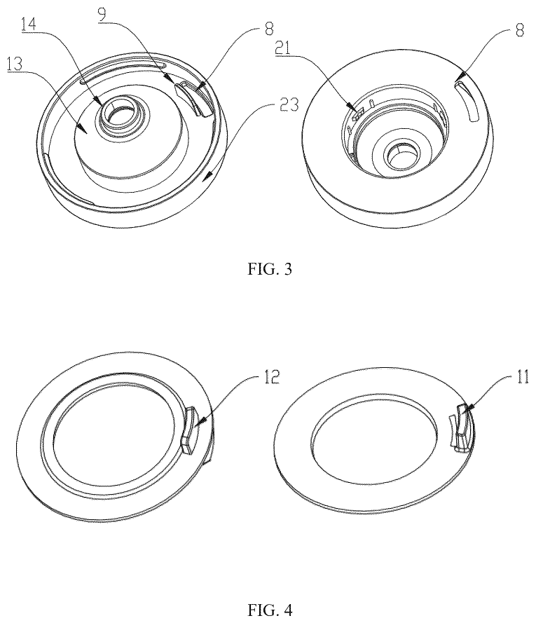

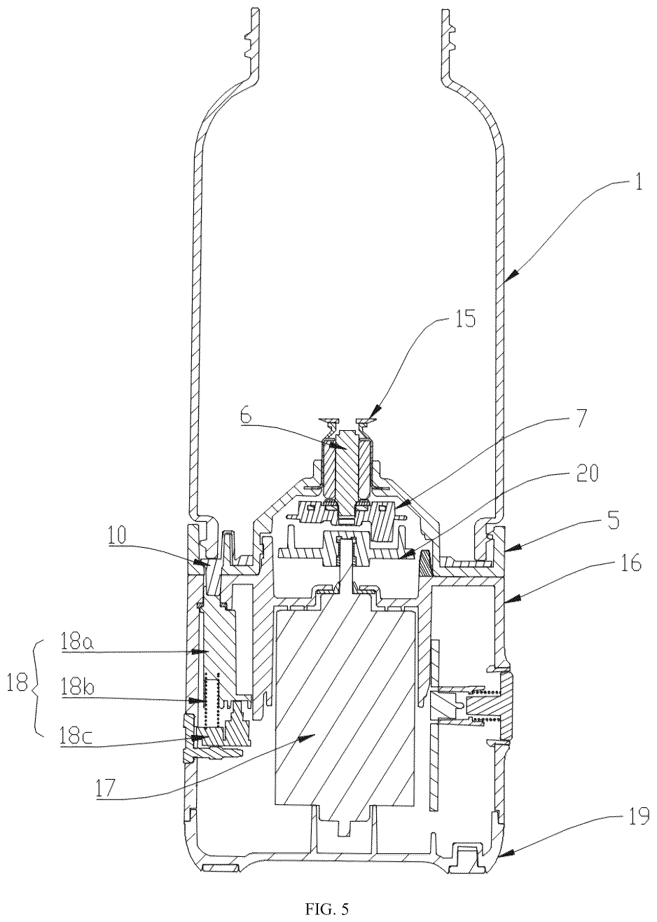

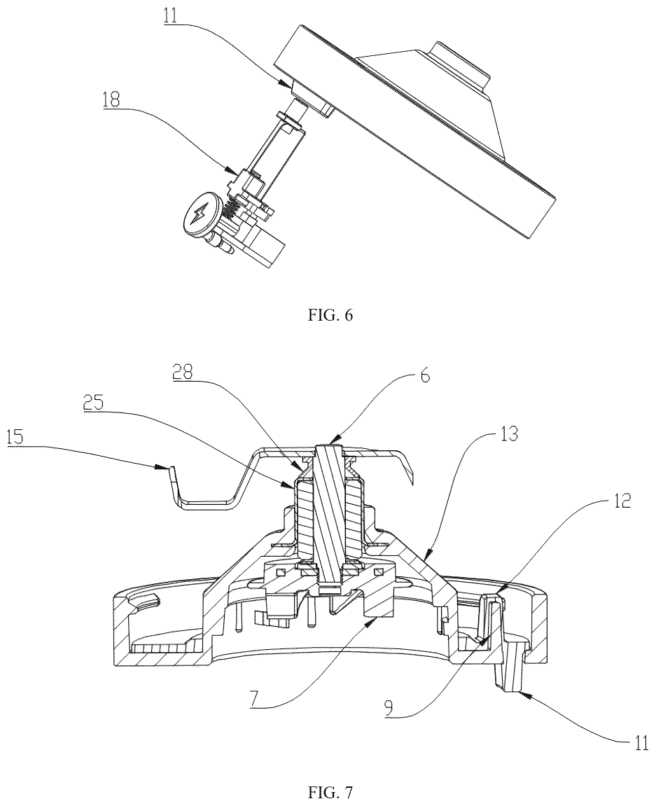

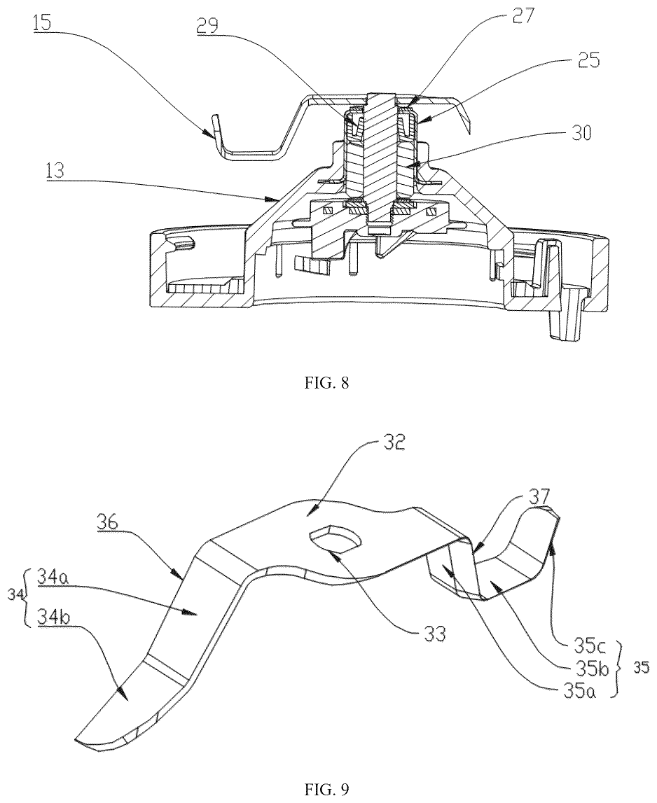

As shown in FIGS. 1-10, a portable blender includes a cup body 1, a blade seat 2 and a machine seat 3, wherein the cup body 1 is detachably connected with the blade seat 2, and the blade seat 2 is detachably connected with the machine seat 3. Since these three elements are independent and detachable in structure, it is easy to disassemble and safely clean them after use.

The two ends of the cup body 1 are open, the upper end is narrowed and connected with the cup cap 4 by means of a thread, and the lower end cup wall is also provided with a thread and connected with the blade seat 2. The blade seat 2 includes a blade tray 5, a rotating shaft 6 and a driven seat 7, the blade tray 5 is provided with a first through hole 8 and a second protrusion 9, a first sealing ring 10 encircles the blade tray 5, the first sealing ring 10 is provided with a solid first protrusion 11 and a hollow sleeve 12 that are arranged in opposite directions, the first protrusion 11 is arranged downwards, just passing through the first through hole 8 of the blade tray, while the hollow sleeve 12 is arranged upwards, fitting with the second protrusion 9 of the blade tray 5. The middle portion of the blade tray 5 sinks upwards and extends to form an installation cavity 13, a second through hole 14 is set on the top of the installation cavity 13, the driven seat 7 is tightly embedded in the inlet of the installation cavity 13. The edge of the blade tray 5 is turned up to form a cylindrical wall surface 23, and the cylindrical wall surface 23 has a long-strip protrusion that is distributed in a spiral direction, and attached to the threaded of the cup body. A bearing 30 is tightly installed at the middle portion of the rotating shaft 6, and the bearing 30 is sleeved with a reinforcing sleeve 25, which is tightly embedded in the installation cavity 13, so as to make the connection of the installation cavity 13 with the rotating shaft 6 and the bearing 30 more firm, and strengthen the stability of the overall structure. The upper end of the rotating shaft 6 stretches out from the second through hole 14; a second sealing ring 28 is sleeved around it, and a stirring blade set 15 is further attached to it; the lower end of the rotating shaft 6 is connected with the driven seat 7 by means of a thread. This connection mode makes the blade seat 2 have a few parts and fair stability in its entirety. A third protrusion 21 is set on the bottom of the installation cavity 13, and the third protrusion 21 is caught by a revolve fastener 24 on the machine seat 3.

In another embodiment, a bearing 30 is tightly installed at the middle portion of the rotating shaft 6; a third sealing ring 29 is arranged at the upper end of the bearing 30, while a reinforcing sleeve 25 is sleeved around it; the reinforcing sleeve 25 is tightly embedded in the installation cavity 13, so as to make the connection of the installation cavity 13 with the rotating shaft 6 and the bearing 30 more firm, and strengthen the stability of the overall structure. The upper end of the rotating shaft 6 stretches out from the second through hole 14; a gasket 27 encircles it, while the stirring blade set 15 is attached to it.

The machine seat 3 includes a housing 16, a control panel 172, a motor 17, a safety switch 18 and a base 19 set at the bottom of the machine seat, and the output end of the motor 17 goes out of the housing16 and has a driving seat 20. An indentation is set at the upper end of the driving seat 20, and is caught by a fifth protrusion 22 of the lower end of the driven seat 7. The safety switch 18 of the machine seat 3 is composed by a spring assembly and a switch 18c; when an external pressure is exerted to press down the spring assembly, the switch 18c makes contact in the motor drive circuit, achieving energization, and when the external pressure disappears, the spring assembly is returned, the switch 18c breaks contact in the motor driving circuit, stopping energization. Specifically, the spring assembly includes a guide block 18a and an ejector spring 18b, the cup body 1 is installed on the blade seat 2, the open end of the cup body 1 enables the first protrusion 11 to overcome an elastic force of the ejector spring 18b and press the guide block 18a toward the switch 18c, so that the switch 18c makes contact in the motor driving circuit. In specific use, the blade seat 2 is installed on the machine seat 3, the first protrusion 11 of the first sealing ring 10 stays against the safety switch 18, but fails to provide a sufficient pressure, so the safety switch 18 remains break-contact, thus the motor driving circuit is switched off; even if the driving button of the motor is pressed at this moment, the motor cannot be energized to operate. When the cup body 1 has been installed in position on the blade seat 2, the cup wall presses the first sealing ring 10 downwards, and then the first sealing ring 10 transmits the pressure to the safety switch 18, in this way the safety switch 18 makes contact in the motor driving circuit; if the driving button of the motor is pressed at this moment, the motor is energized to operate. This design can improve the safety of the machine. In addition, as the second protrusion 9 of the blade tray 5 is set at the position close to the wall of the blade tray, and the first through hole 8 lies between the second protrusion 9 and the cylindrical wall surface 23, fingers cannot stretch into it, so as to avoid a potential safety hazard caused by accidental touching. This protrusion 9 of the blade tray 5 also performs the function in stirring and disturbing flow, improving stirring effect.

The stirring blade set 15 includes a wing base 32, and a first blade wing 34 and a second blade wing 35 that extend outwards from a periphery of the wing base 32 and are positioned opposite to each other, the center of the wing base is provided with a installation hole 33; the stirring blade set 15 can be installed on the rotating shaft of the blade seat of the blender by means of the installation hole 33, in this way the blade is driven to rotate under the rotation of the rotating shaft. These two blade wings are different in shape and bending. The first blade wing 34 is set to be a two-section structure bent downwards in L-shape with respect to the plane of the wing base 32; specifically, the angle α formed by bending the first section 34a of the first blade wing downwards with respect to the plane of the wing base 32 is 45-80°, and the angle β formed by bending back the second section 34b of the first blade wing upwards with respect to the first section 34a of the first blade wing is 20-40°. It can be seen that the main function of the first blade wing 34 is to stir and crush materials that sink to the bottom of the mixing cup. The second blade wing 35 is set to be a three-section structure bent downwards in U-shape with respect to the plane of the wing base 32; specifically, the angle γ formed by bending the first section 35a of the second blade wing downwards with respect to the plane of the wing base 32 is 45-80°, the angle θ formed by bending back the second section 35b of the second blade wing upwards with respect to the first section 35a of the second blade wing is 45-80°, so that the size of θ is equal to γ, the angle ζ formed by bending the third section 35c of the second blade wing upwards with respect to the second section 35b of the second blade wing is 60-85°. Because the three sections 35c of the second blade wing are an upward inclined plane, the second blade wing 35 not only has the function of stirring and crushing materials, but also forms a vortex in rotation, which pushes the materials at the bottom to move upwards, so as to make it possible to more evenly disperse the materials, and more fully stir them.

Preferably, in this embodiment, the angle α formed by bending the first section 34a of the first blade wing downwards with respect to the plane of the wing base 32 is 65°, the angle β formed by bending back the second section 34b of the first blade wing upwards with respect to the first section 34a of the first blade wing is 30°, the angle γ formed by bending the first section 35a of the second blade wing downwards with respect to the plane of the wing base 32 is 65°, the angle θ formed by bending back the second section 35b of the second blade wing upwards with respect to the first section 35a of the second blade wing is 65°, the angle ζ formed by bending the third section 35c of the second blade wing upwards with respect to the second section 35b of the second blade wing is 80°.

In addition, a first blade 36 positioned on the first blade wing 34 and a second blade 37 positioned on the second blade wing 35 are staggered from each other and arranged on opposite sides with respect with each other; when the blade rotates clockwise, the blade cuts the materials with its forward cutting edge. In addition, the blade wing and the wing base 32 are made into a one-piece, so that the blade structure is more solid and not easy to be damaged. Compared with a blade structure composed by two or more independent blades commonly used in existing blenders, the blender according to the present invention is simpler and more firm in structure.

In this technical solution, the stirring blade set of the portable mixer adopts an integrally-formed single-blade structure, and the blade wings on both sides are respectively bent in L-shape and in U-shape with the advantages of providing a simple structure meanwhile ensuring stirring efficiency, so as to make it convenient to clean and maintain the blender and possible to prolong service life, improve users'experience, save materials and reduce costs.

As an improvement, the present invention also provides a wireless (Cordless) portable blender, which further includes a lithium battery 171 inside the machine seat; the lithium battery provides electricity to the motor, and can be used free of power cords conducting alternating current.

### Example 2

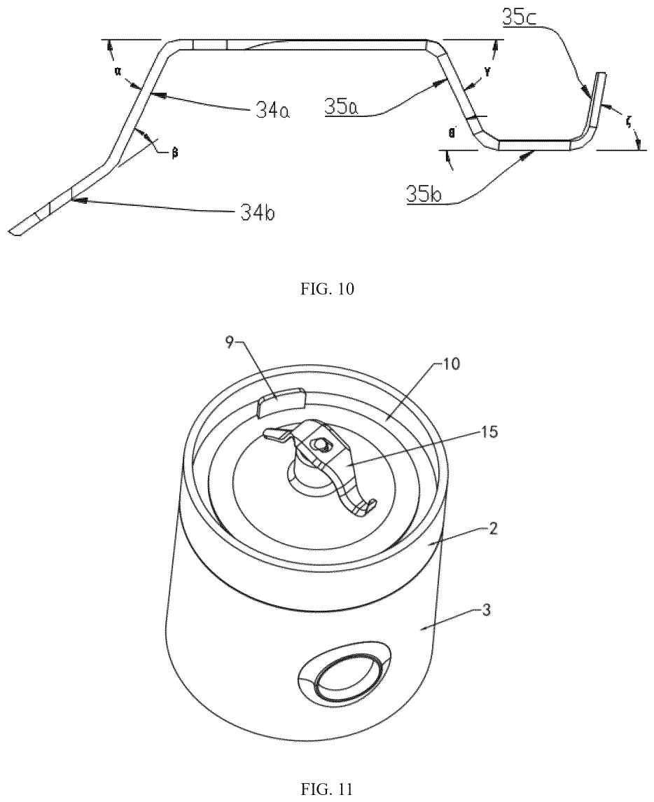

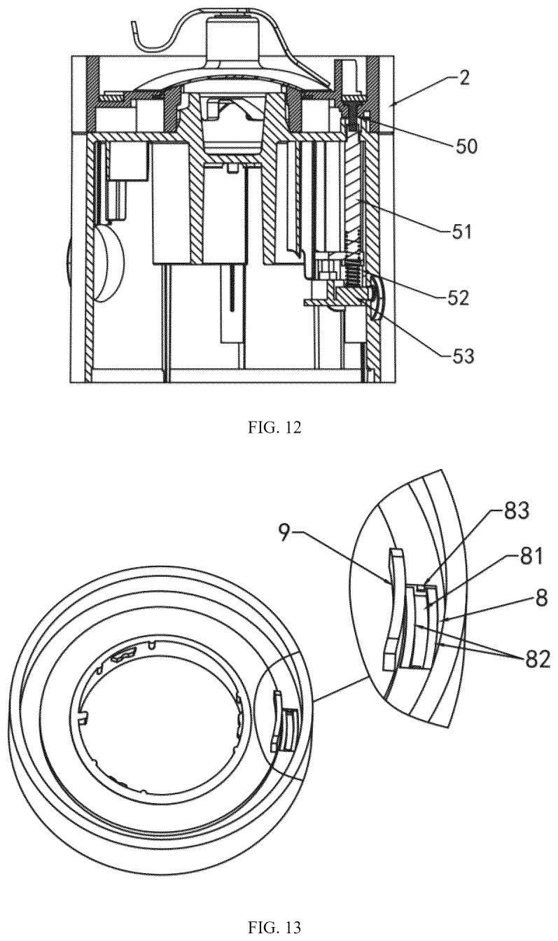

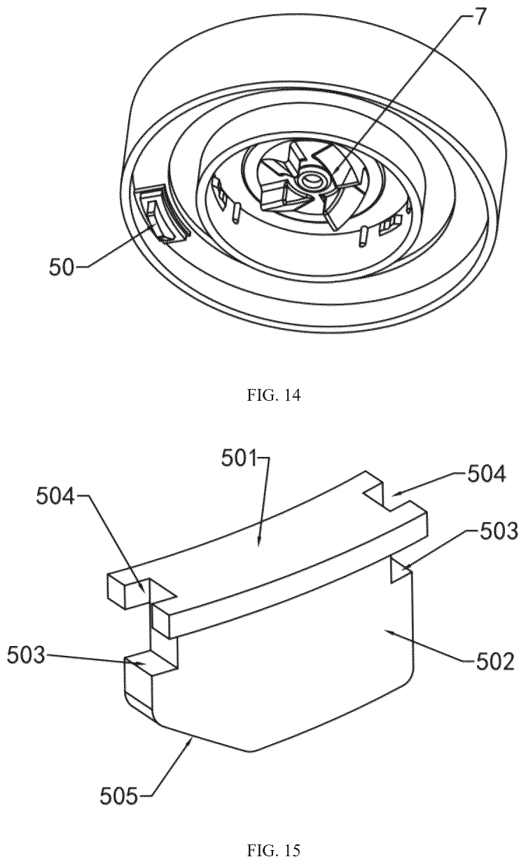

As shown in FIGS. 11-15, the first protrusion and the first sealing ring are set as separate structures, the first protrusion is a switching movable piece 50, the first through hole includes a slot hole 81 and a pair of supporting plates 82 that are respectively arranged at two opposite sides of the slot hole in a shape similar to a rectangle, the slot hole 81 is sandwiched between the two supporting plates, the switching movable piece 50 includes a partition 501 and a rising plate 502, the partition 501 is arranged on the pair of supporting plates 82, and the rising plate 502 is inserted into the slot hole 501.

Two wall portions of the slot hole opposite to each other are respectively provided with a position-restricting block 83; correspondingly, the two sides of the rising plate 502 are provided with an anti-falling block 503, the position-restricting block is positioned above the anti-falling block, and prevents the anti-falling block from being pulled upwards from the slot hole. The partition 501 is provided with a partition notch 504, and the partition notch is configured to dodge the position-restricting block 83. A wedge surface 505 is set on one side of the bottom of the rising plate 502, the wedge surface 505 is configured to guide the rising plate to pass over the position-restricting block 83, so that the anti-falling block 503 passes through a switching groove and is positioned below the position-restricting block 83.

A jacking spring 52 is arranged between a spring seat 53 and a switching jacking rod 51. When the cup body leaves the blade seat, the opening edge of the cup body fails to exert a pressure on the first sealing ring 10, so that the jacking spring 52 can jack up the switching movable piece 50; thus, the switching jacking rod 51 no longer presses the safety switch, and the safety switch breaks contact.

Although embodiments of the present invention have been shown and described, it is understandable for a person killed in the art that a variety of changes, modifications, substitutions and variants may be made to these embodiments without departing from the principle and essence of the present invention, and the protection scope of the present invention is defined by the claims and their equivalents.

1. A portable blender comprising a cup body, a blade seat, a machine seat, and a control panel, a motor and a driving seat that are arranged inside said machine seat, said motor driving said driving seat to rotate, characterized in that said cup body is detachably connected with said blade seat, said blade seat is detachably connected with said machine seat, said machine seat is provided with a safety switch, said blade seat includes a blade tray, a rotating shaft, a stirring blade set and a driven seat, said blade tray is provided with a first through hole, a first sealing ring encircles said blade tray, said first sealing ring is provided with a first protrusion, which passes through said first through hole, and said first protrusion is used to support said safety switch.

2. The portable blender according to claim 1, characterized in that said stirring blade set includes a wing base, and a first blade wing and a second blade wing that extend outwards from a periphery of said wing base and are positioned opposite to each other, the center of said wing base is provided with a installation hole, a blade is set on each of these blade wings, said first blade wing is set to be a two-section structure bent downwards in L-shape with respect to a plane of said wing base, and said second blade wing is set to be a three-section structure bent downwards in U-shape with respect to the plane of said wing base.

3. The portable blender according to claim 1, characterized in that said blade tray is provided with a second protrusion, said second protrusion is set to be adjacent to said first through hole, said first sealing ring is provided with a hollow sleeve, and said second protrusion is adapted to and inserted in said hollow sleeve.

4. The portable blender according to claim 3, characterized in that a middle portion of said blade tray sinks upwards and extends to form an installation cavity, a second through hole is set on a top of said installation cavity, a third protrusion is set on a bottom of said installation cavity, and said third protrusion is caught by a revolve fastener on said machine seat.

5. The portable blender according to claim 3, characterized in that said safety switch includes a spring assembly and a switch, said switch is used to make contact or break contact in a motor driving circuit, and said spring assembly includes a guide block and an ejector spring, said cup body is installed on said blade seat, an open end of said cup body enables said first protrusion to overcome an elastic force of said ejector spring and press said guide block toward said switch, so that said switch makes contact in said motor driving circuit.

6. The portable blender according to claim 5, characterized in that an angle α formed by bending a first section of said first blade wing downwards with respect to the plane of said wing base is 45-80°, an angle β formed by bending back a second section of said first blade wing upwards with respect to the first section of said first blade wing is 20-40°, an angle γ formed by bending a first section of said second blade wing downwards with respect to the plane of said wing base is 45-80°, an angle θ formed by bending back a second section of said second blade wing upwards with respect to the first section of said second blade wing is 45-80°, an angle ζ formed by bending a third section of said second blade wing upwards with respect to the second section of said second blade wing is 60-85°.

7. The portable blender according to claim 6, characterized in that an edge of said blade tray is turned up to form a cylindrical wall surface.

8. The portable blender according to claim 1, characterized in that it further comprises a battery inside said machine seat; said battery provides electricity to said motor.

9. The portable blender according to claim 1, characterized in that said first protrusion and said first sealing ring are set as separate structures, said first protrusion is a switching movable piece, said first through hole comprises a slot hole and a supporting plate, said switching movable piece includes a partition and a rising plate, said partition is arranged on said supporting plate, and said rising plate is inserted into said slot hole.

10. The portable blender according to claim 9, characterized in that a position-restricting block is arranged at a wall portion of said slot hole, said rising plate is provided with an anti-falling block, said position-restricting block is positioned above said anti-falling block, and prevents said anti-falling block from being pulled upwards from said slot hole, and said partition is provided with a partition notch, which is configured to dodge said position-restricting block.
